(19) United States
(12) Patent Application Publication
(10) Pub. No.: US 2008/0055097 A1
(43) Pub. Date: Mar. 6, 2008

(54) Versatile Network of Building Alarm Modules

(76) Inventors: David Welford Chidakel, Wellesley, MA (US); William Harris Groves, Arlington, MA (US); Paul A. Boduch, Northampton, NH (US); Michael Ellsworth Beach, Somerville, MA (US)

Correspondence Address: David Chidakel, 6 Colby Road, Wellesley, MA, 02482, US

(21) Appl. No.: 11/683,423

(22) Filed: Mar. 7, 2007

Related U.S. Application Data
(60) Provisional application No. 60/842,330, filed on Sep. 5, 2006.

(51) Int. Cl. G08B 17/10

(52) U.S. Cl. 340/628

(57) ABSTRACT

A system of interconnected alarm modules for a building which warn of detectable hazards in and around the building as well as hazards such as natural disasters which originate elsewhere. The network includes at least one hazardous condition alarm module, capable of detecting dangerous conditions in and around the building such as carbon monoxide or smoke and which provides an audible warning accordingly and also transmits hazard-specific data through the network to all other alarm modules. For other types of hazard conditions, the network includes a radio receiver alarm module which receives broadcasts such as those from the National Oceanic and Atmospheric Administration that includes encoded data about hazards according to type of hazard and geographic location. When the radio receiver alarm module receives a broadcast which contains data indicating a threat for the geographic area to which it is preprogrammed, it provides an audible warning accordingly and also sends data, specific to the type of threat, to all other connected alarm modules. Each connected alarm module responds to data received from other interconnected alarm modules by generating audible alarm warnings specific to the type of threat. The radio receiver alarm module may be capable of receiver other types of radio or satellite broadcasts. Electric power to the network is preferably supplied by the building's power mains but may also be provided by a battery backup in the event of a power failure. This invention increases the usefulness of distributed hazardous condition detection systems, allowing them to warn about a great variety of dangers such as tornadoes, earthquakes and terrorism as well as the presence of smoke or other substances for which they were originally intended.

### BACKGROUND OF THE INVENTION

1. Field of the Invention

The present invention relates generally to a warning system for buildings which generates alarms for a multiplicity of threats. More specifically, the present invention relates to a network of sensor-based devices such as, but not limited to, smoke detectors and carbon monoxide detectors (such network referred to herein as a distributed hazardous condition detection system) which interconnects with and is augmented by a radio receiver alarm module for warnings of external hazards. This network, therefore, alerts those present in the building to both internal and external threat conditions. The radio receiver alarm module, which uses the distributed hazardous condition detection system to disseminate disaster-related alarms throughout a building, contains a radio receiver for encoded location-specific disaster alerts broadcast from a source such as the National Oceanic and Atmospheric Administration.

2. Description of the Related Art

People are subject to a variety of potential hazards as they carry out their activities at work, at play, and at home. Such hazards include things like noxious gases and fire—things which sensor-based “hazardous condition detectors” can identify.

The most widely used device in this category, the smoke detector, is universally accepted throughout the United States. The US National Building Code requires that new homes and multi-family residences have hard-wired smoke detectors in each sleeping area, one outside each bedroom area that is close enough to be heard through closed doors, and a minimum of one smoke alarm on each level of the home. There are also requirements for office and commercial buildings.

In addition to smoke detectors, carbon monoxide detectors are required now in many areas of the country. Detectors are also available for other types of threats such as natural gas.

Hazardous condition detectors routinely save lives and property, alerting those present in a building to an imminent disaster in time for them to exit the premises. The protective value of these devices is widely recognized.

In addition to hazards that can be detected on-premises, such things as tornadoes, earthquakes, and terrorist attacks which, generally, originate off-premises and, generally, can not be identified by inexpensive building detectors are now referred to, collectively, under the aegis of “Homeland Security”. Currently, the dissemination of Homeland Security radio alerts (including weather-related threats) are the provenance of the National Oceanic and Atmospheric Administration which broadcasts them on its VHF/FM radio network along with encoded data describing each such threat along with a “Federal Information Processing System” (FIPS) codes describing the particular geographic areas affected.

Weather radios (and certain televisions) which use this system include means for self-activation when a preprogrammed geographic code has been transmitted. Thus, a broadcast of threat alerts intended to cover only a certain area (e.g., a county), will be preceded by a “FIPS” code for that county. Only radios and televisions which have been set to that specific code will be activated by the broadcast to produce a suitable alarm and/or voice broadcast of the event.

Weather warning radios and televisions are a great advance. They can, inexpensively, provide an immediate warning of danger, saving lives which can be lost—as, indeed, they have been in the past—while traditional warning methods such as sirens and public address systems are still in the process of being deployed. The “instant on” feature, wherein the receiver “wakes up” when its signal contains an embedded code for the selected geographic area, increases its utility in a true emergency. But, for the protection of an entire building, numerous radios would have to be positioned strategically throughout a building. Geographic codes and other information would have to be programmed individually into each radio and maintained which would be impractical. In addition, radio reception varies within a structure and some locations (within the interior of a structure or in a basement, for example) may afford no reception at all. Furthermore, a permanent deployment of such radios throughout a structure would either require, inconveniently, access to a power outlet for each or (less convenient still) frequent battery changes. And finally, the actual use of such radios is currently haphazard in that some individuals purchase and use them while the majority does not. Thus, while disaster (weather) radios are a step in the right direction for individual safety, they do not, in general, provide adequate protection for a building.

Accordingly, a need will be seen to equip buildings of all kinds with a network of interconnected alarms which warn of a wide range of potential dangers from fire to natural disaster to malicious human activities. Such a system provides audible alarms and, optionally, stored voice messages for each such condition even in buildings where the quality of radio reception is variable. The system may be powered by standard household electrical power, and may include backup battery power.

A discussion of the related art of which the present inventor is aware, and its differences and distinctions from the present invention, is provided below.

U.S. Pat. No. 4,155,042, issued on May 15, 1979, to Albert A. Permut, Alan R. Permut, and Ronald M. Permut, titled “Disaster alert system,” describes a way for localities which currently rely on sirens, public address systems, and commercial radio to notify local residents of an impending disaster, to go to a system of direct radio frequency notification, broadcasting encoded signals to devices that are installed in the homes of the citizenry. This is a worthy idea and one would hope to see it succeed. As of this time, the National Oceanic and Atmospheric Administration appear to have taken the lead in direct broadcasts of disaster-related data but an additional source of broadcast data for the present invention would be desirable.

There are numerous patents (such as U.S. Pat. No. 3,753,117 issued on Aug. 14, 1973 to George C. Downing and Thomas V. McEwen, titled “Severe Weather Warning Device,” describing an electronic device for detecting electromagnetic energy from an electrical storm) for devices which identify dangerous natural phenomena such as tsunamis, storms, and earthquakes. While the occupants of individual homes or buildings can not, reasonably, be expected to deploy and manage an array of such devices, the present invention offers a practical way for the occupants of such structures to obtain advance warning of similar dangers.

U.S. Pat. No. 4,949,077 issued on Aug. 14, 1990 to David C. Mbuthia, titled “Portable Unit With Smoke Alarm, Clock Radio, Compass, Retractable Table, And Lamp,” describes a device incorporating (among other things) a smoke detector and radio. The device is of valuable to a traveler staying in a hotel or motel room, and offers several desirable features in a single package. However, the invention includes neither the means to “wake up” the described radio in an emergency nor the means to interconnect to similar devices throughout a building. Hence, Mbutia's invention, while useful in one room during certain hours, wouldn't provide overall night and day protection for a building. By contrast, this invention protects all areas of the premises in which it is installed with clearly audible and distinctive warnings specific to each type of threat.

U.S. Pat. No. 7,145,466 issued on Dec. 5, 2006 to John R. Haynes, and to Larry A. Zimmerman, titled “National Security Warning System Integrated with Building Fire Alarm Notification System” describes a centralized fire alarm system (a “code compliant fire alarm panel”) which warns of on-premises fires based on heat, smoke, or fire detectors and which can, in addition, receive broadcast signals warning of additional hazards. These “external” hazard warnings are used by the device's “notification appliance” to alert the building about the broadcast warnings.

Fire alarm systems such as the single controller system described by Haynes and Zimmerman constitute a valuable part of the nation's safety systems and the addition of radio alerts would extend their value. But in recent years, low cost, easily installed, and very reliable interconnected smoke detectors have become popular—especially in residences. Although they lack the means to notify fire departments, they do provide fire and smoke warnings that have saved many lives; and because of their simplicity and low cost, smoke detectors are required throughout the United States. This invention adds the advantages of broadcast alerts to smoke detectors much as Haynes and Zimmerman's invention adds them to centralized fire alarms systems.

U.S. Patent Application No. 20070013532 published on Jan. 18, 2007, submitted by George A. Ehlers, titled “Combination Thermostat and Warning Device with Remote Sensor Monitoring” describes a combination thermostat and warning device (in a common housing) and refers to its use as a possible alarm source for a smoke detector system. A combined smoke detector/weather radio may have utility in some cases, saving space and placing the radio receiver in a convenient place. But the best location for a thermostat may be a poor choice for a radio receiving device which relies on good radio reception. And it is far from clear that there is a universal desire to combine these two seemingly unrelated functions, adding additional cost and complexity whereby a problem with the thermostat could necessitate replacement of the entire unit. Because heating specialists are not normally trained in alarm systems, replacing such a device may be unexpectedly difficult. The more useful approach, described here, is to feed alarm signals from a radio alarm module which, unencumbered by a thermostat, can be positioned for optimal signal reception.

British Patent Publication No. 2,280,295 published on Jan. 25, 1995, on behalf of its inventors, Benedict Chaplin Spencer and Aelred Richard Spencer, titled “Portable Smoke Detector,” describes a detector including means for connecting to other detectors. The connection means is a receptacle in the case, providing for hard wired communication between units. It is valuable to interconnect (network) the modules of detectors but this invention is limited to detection of smoke only and doesn't offer protection against any off-premises threats or against any on-premises threats beyond smoke alone.

Finally, U.S. Pat. No. 6,121,885 issued on Sep. 19, 2000 to Reagan Masone, Tony Masone, and David Edins titled “Combination smoke detector and severe weather warning device,” describes a device that functions as a detector for smoke and other hazardous conditions as well as a device which receives disaster alerts from the National Oceanic and Atmospheric Administration. Reacting to both internal and external threats with a single unified alarm system is a sound approach but physically combining the radio receiving element with the hazardous condition detection element is problematic. Locations within a building that are appropriate for sensing smoke or other substances do not always afford adequate radio reception. Without radio reception, the device can not function properly.

None of the above inventions and patents, taken either singly or in combination, is seen to describe the instant invention as claimed.

### SUMMARY OF THE INVENTION

Accordingly, it is a principal object of this invention to provide means for connecting a disaster alert radio receiver to alarm devices such as smoke detectors, taking advantage of the interconnectivity of modern hazardous detection systems to create a more flexible system whereby a single radio receiver alarm module transmits its alarm signals over the common network. Because only one radio receiver alarm module is required, it can be positioned for optimum radio reception and reduce the need for redundant antennas and electronics. Accordingly, the resulting system is inexpensive to manufacture and easy to install and extends the usefulness of distributed hazardous condition detection systems, allowing them to warn about a multiplicity of dangers such as tornadoes, earthquakes and terrorism as well as the presence of smoke or other substances for which they were originally intended.

It is a further object of the invention to provide an improved hazardous condition detection system which provides specific audible stored voice announcements and or alarm sounds for each hazard that is detected in or about a building by its hazardous condition alarm modules as well as for each type of threat code received over the network from the radio receiver alarm module.

Still another object of the invention is to provide a flexible networked disaster warning system for buildings which system receives primary electrical power from building's electric mains and which system, in the event of a power failure, provides a battery backup.

It is an object of this invention to provide improved elements and arrangements thereof in a network for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWING

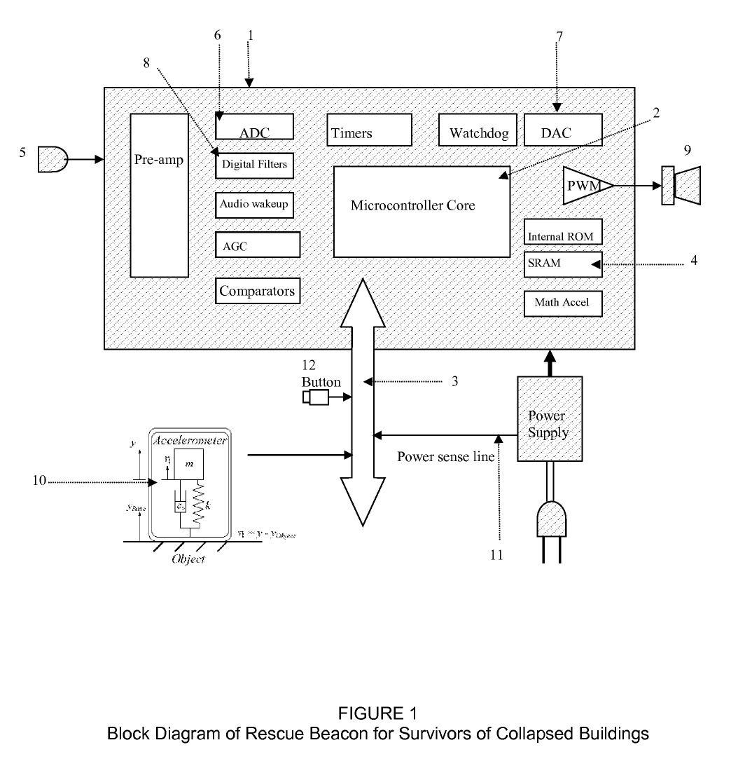

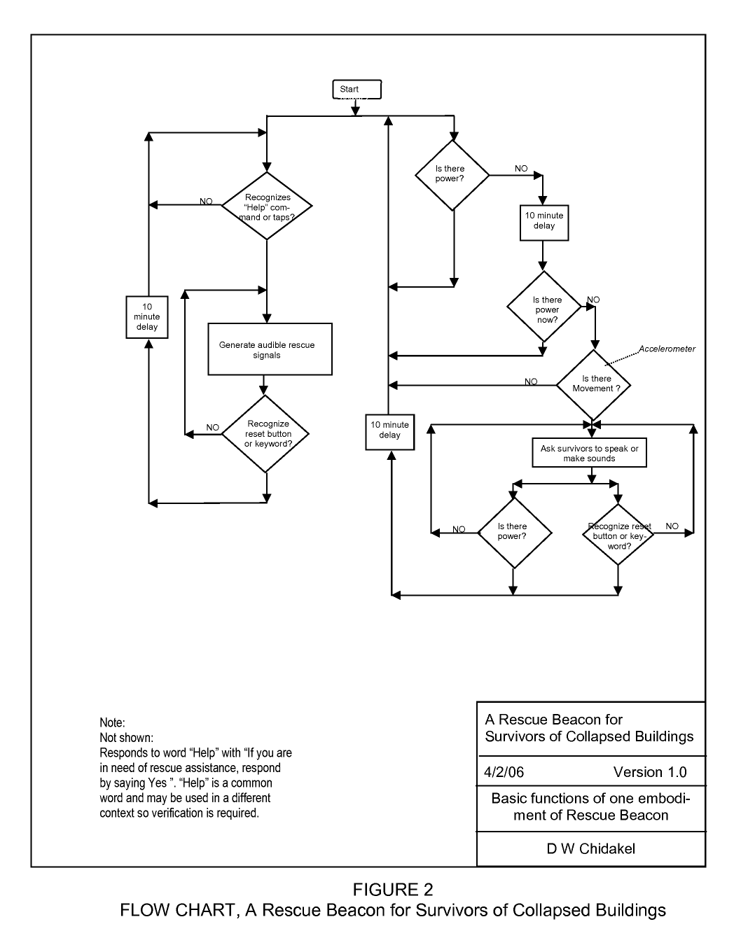

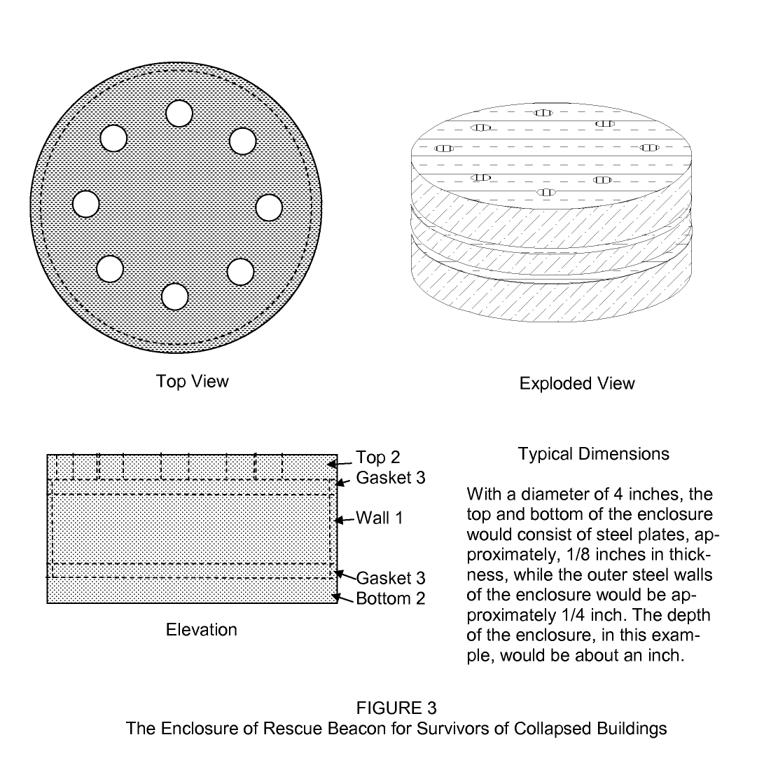

The drawing FIG. 1 is a block diagram, describing a Radio Receiver alarm Module of the exemplary system, a Hazardous Condition Alarm Module of the system and showing the connections between them.

### DETAILED DESCRIPTION OF THE PREFERRED EMBODIMENT

The present invention comprises a radio receiver alarm module 1 containing a microprocessor and associated electronics 2. Said radio receiver alarm module is connected to at least one hazardous condition detector such as a smoke detector. Said radio receiver alarm module is capable of receiving hazard alerts encoded onto a radio signal such as those from the National Oceanic and Atmospheric Administration and may, additionally, be capable of receiving other types of radio or satellite broadcasts. The radio receiver alarm module, itself, is preferably, and in this example, attached to the wall at a convenient height and wired into, or otherwise connected to, the building's electrical supply. Said radio receiver alarm module is, as well, connected to other alarm devices such as smoke detectors or carbon monoxide detectors which alarm devices are, themselves, interconnected.

Each connected alarm module responds to data bits received from other interconnected alarm modules by generating an audible alarm and, in this example, stored voice messages specific to the threat.

The housing of the alarm modules may have any appearance or configuration desired, so long as appropriate conventional apertures, openings, and/or passages are provided for access to such internal components as function controls, battery access for replacement, connections for external or remote components, and so on.

Each hazardous condition alarm module 3 includes at least one sensor, switch or transducer from which it accepts an input signal. In this example, each such module comprises a combination smoke and carbon monoxide detector with sensors 4 and 5 and said hazardous condition alarm module contains a microprocessor and associated electronics 6. The hazardous condition alarm module emits an audible alarm and stored voice message utilizing its speaker 7 when either smoke or carbon monoxide is detected and, as well, sends data bits for each type of alarm condition to all other alarm modules through the power and network interface 8 which is wired 9 in this exemplary system but is not limited thereto and could otherwise use wireless means. Optionally, a remote visual alarm such as a strobe 10, 11 may be utilized.

Optionally, but not in the exemplary system, warnings could be shown using stored messages (e.g., “THUNDERSTORM,” “TORNADO,” “FLASH FLOOD,” etc.) on a display 12, 13 in each alarm module. Alternatively, indicators lights in each alarm module could be used as, for example, a red light could be illuminated to indicate a tornado, a yellow or amber light for a mudslide, and a blue light for an earthquake and so on. Such lights or such displays could be incorporated into the housings of each module.

The alarm modules 1 and 2 are connected through the power and network interfaces 8 by wires some of which, in this exemplary system, supply power to each module. The power supply 14, preferably, and in this example, a part of the radio receiver alarm module 1 receives alternating electric current from the building's electrical supply mains 15 and reduces the voltage and rectifies the current to provide power to each of the modules connected to the network. Other means of providing power to the alarm modules are possible. A backup battery 16 is also provided, with the system automatically switching from the power supply 14 to the backup battery 16 in the event of a power interruption. A low battery power warning means is a blinking light 17,18 in this example but is not limited thereto. Alternatively, a low battery warning means could include intermittent audible and/or visual warnings as well as continuous sounds or lights or text messages. In the exemplary system's power supply 14, circuitry is provided for charging and maintaining the backup battery 16. While wires are used to interconnect each alarm module in the exemplary system, it is quite feasible to use a wireless interconnection means provided that each module is fitted with its own power supply.

The exemplary system's radio receiver alarm module is tuned to the broadcast bands of the previously mentioned National Oceanic and Atmospheric Administration. The radio receiver alarm module of the exemplary system includes means for setting the previously mentioned FIPS code, selecting the broadcast frequency which has the strongest signal, and other setup functions which means include a keypad 19, a display 12, and a speaker 20 for the radio receiver alarm module. Said speaker is also used to emit alarms. An optional external antenna 21 enhances reception in areas where the signal is too weak for the internal antenna 22.

Each module in the exemplary system contains a power switch 23, 24.

In summary, this invention, and the exemplary system, provide a much-needed integration of hazard warnings combining, in one system of networked building alarms, warnings that can be sensed on-premises by specialized alarm devices such as smoke detectors with warnings that are commonly gathered off-premises by public or private institutions which institutions warn of threats from natural disasters or intentional acts such as terrorism. The exemplary system includes warning means for both smoke and carbon monoxide and for disasters of both natural and malicious origin in a network where, preferably, all components use a common electrical power supply and a common set of interconnecting (network) wires. The system's power supply is, in turn, connected to electrical power supplied to the structure with an integral backup battery. The present invention is suited for permanent installation in any inhabited structure where it can provide timely warning of disasters.

Accordingly, this invention extends the usefulness of distributed hazardous condition detection systems, allowing such systems to warn about a multiplicity of dangers such as tornadoes, earthquakes and terrorism as well as the presence of smoke or other substances for which such systems were originally intended and giving the occupants of buildings protected by such the opportunity to preserve life and property.

It is to be understood that the present invention is not limited to the sole embodiment described above, but encompasses any and all embodiments within the scope of the following claims.

We claim:

1. A system of interconnected alarm modules for a building which warn of hazards in and around said building as well as hazards that originate elsewhere and which system comprises:
at least one hazardous condition detection alarm module with means for detection of at least smoke;
a radio receiver alarm module which receives broadcasts such as those of the National Oceanic and Atmospheric Administration of the United States government including encoded data of disasters by hazard type and geographic location;
said radio receiver alarm module including:
means for selecting and setting a geographic code such as the Federal Information Processing System codes of the National Oceanic and Atmospheric Administration, as well as means for selecting and setting a preferred broadcast signal frequency
means for setting up various features of said radio receiver alarm module

2. The system of interconnected modules of claim 1 whereby said modules provide means for data intercommunication from one module to another

3. The system of interconnected modules of claim 1 wherein said module includes means for emitting alarms for each type of hazard

4. The system of interconnected modules of claim 1 wherein said module includes means for annunciating stored voice messages appropriate to each type of hazard

5. The system of interconnected modules of claim 1 wherein said electrical power source comprises an electrical supply and a backup battery power supply in the event of a power failure

6. The system of interconnected modules of claim 1 wherein said alarm means is selected from the group consisting of an audible alarm and a visual alarm

7. The system of interconnected modules of claim 1 wherein said visual alarm comprises a strobe light

8. The radio receiver alarm module of claim 1 wherein said radio receiver alarm module provides means to interconnect with conventional hazard condition detection devices and activate the alarms of said hazard condition devices when hazard data is received by said radio receiver alarm module, thus making it possible to add said radio receiver alarm module to an existing network of hazardous condition alarm modules

9. The radio receiver alarm module of claim 1 including a remote keypad for communicating with said receiving means

10. The radio receiver alarm module of claim 1 wherein said programming display means is selected from the group consisting of light emitting diode and liquid crystal display means
